(19) United States
(12) Patent Application Publication
(10) Pub. No.: US 2025/0036870 A1
(43) Pub. Date: Jan. 30, 2025

(54) ACTIVE INFERENCE ARCHITECTURE FOR OPTIMIZING LARGE LANGUAGE MODEL RESPONSES

(71) Applicant: Brain Electrophysiology Laboratory Company, LLC, Eugene, OR (US)

(72) Inventors: Don M. Tucker, Eugene, OR (US); Phan Luu, Eugene, OR (US); Roman Shusteman, Lake Oswego, OR (US)

(21) Appl. No.: 18/882,546

(22) Filed: Sep. 11, 2024

(51) Int. Cl. G06F 40/226

(52) U.S. Cl. CPC G06F 40/226

(57) ABSTRACT

A method for controlling the behavior of Large Language Models (LLMs) based on the principles of active inference that are integral to human natural language behavior and are thereby manifest implicitly by LLMs. These principles are similar to the actor component of control systems that achieve optimal behavior when conditions of the system's fit to the environment are known and feedforward control is best, compared to more uncertain conditions when close feedback from external criteria is needed to guide behavior optimally by the external evidence. The structured prompting of LLMs then achieves the single optimal response for both the generative creativity of the LLM response and the accuracy and control of the response through alternating, and then integrating, the contextual prompts according to these principles.

### BACKGROUND

The present disclosure relates to methods for optimizing the responses of Large Language Models (LLMs) through a prompting architecture inspired by the principles of active inference in human cognition. LLMs are powerful tools capable of generating responses across various domains. However, they often face challenges related to response accuracy and reliability due to their intrinsic non-deterministic nature. Addressing these issues is crucial, particularly in applications requiring high reliability, such as medical, legal, or educational fields.

Previous inventions have proposed improved prompting of LLMs to improve accuracy and reliability. Tunstall-Pedoe et al. (U.S. Ser. No. 11/989,507) focused on minimizing hallucinations in LLM responses by translating outputs into a machine-readable “universal” language, which enhances the validation process of generated content. This approach aims to improve the reliability of LLMs by ensuring that the output can be systematically verified against known data or models. Cai et al. (US20230112921A1) describe a method for enhancing the interpretability and stability of LLM outputs by chaining multiple queries and responses. The technique involves structuring the interaction between the LLM and the user in a sequential manner, which helps clarify the context and intent of the responses, thereby reducing ambiguity and increasing the accuracy of the output. Aberle (U.S. Ser. No. 11/748,577) addresses the improvement of language model responses through the use of structured language organization to refine the specificity of user requirements. By guiding the LLM to focus on more precise input, the quality and relevance of the generated responses are enhanced, reducing the likelihood of producing irrelevant or inaccurate information.

These prior inventions provide methods for improving LLM outputs by focusing on validation, interpretability, stability, and input specificity. The present invention introduces a novel approach to sequentially enhance both the creativity and accuracy of LLM responses through a dynamic process of generation and feedback.

The differential advantages properties of generative or feedforward control, contrasted with restrictive or feedback control, are well known in the robotics literature, such as in actor-critic software architectures. The present inventors have recognized that the scientific insights into human cognition, captured in the theory of active inference (Luu, Tucker. & Friston, 2024), suggest that human language cognition begins with a generative stage in which expectancies frame the initial stages of the semantic space, and then it progresses to a critical stage in which evidence of external facts serve to correct the errors in the semantic construction. A familiar reflection of these intrinsic mechanisms of human linguistic association is the well-known agent, action, object model of language (noun, verb, object structure of English sentences), reflecting the initial generative impetus followed by the object-based constraint of the action's effect. By developing prompting strategies based on the specific principles of active inference, the present invention draws on the fact that human neurolinguistic structure is implicit to LLMs, so that an optimal prompting strategy can be organized based on neurolinguistic principles.

### SUMMARY OF THE INVENTION

This invention introduces a structured method for enhancing both the creativity and accuracy of LLM responses by employing a dual-component prompting method including a first process that emphasizes generative creativity and a second process that emphasizes critical evaluation and validity of the first process. The generative component is responsible for producing initial responses to user queries, aiming to produce novel and creative outputs. The second critical component subsequently evaluates these responses, focusing on ensuring accuracy, relevance, and reliability before presenting the final output to the user.

These differential methods of prompting or guidance of the LLM are derived from the inventors' insight that the structure of the associations in LLMs are based on a human language corpus that reflects the inherent neurocognitive patterns of human verbal reasoning.

In the theory of active inference from computational neuroscience (Friston & Frith, 2015), human cognition is modeled as a process of generating and refining predictions about the environment. In this framework, initial predictions (expectancies) are generated by the brain's generative function, which is driven by a projectional, feedforward motivational process, described as the impetus (Luu et al., 2024). These predictions are then refined by the corrective feedback based on incoming sensory evidence and internal constraints (termed the artus, associated with anxiety and self-aware criticism) (Luu et al., 2024). By constructing a prompting strategy that aligns with these inherent control systems of the human brain, the present invention achieves an optimal prompting strategy for LLMs that is superior to the empirical engineering prompting strategies currently in use.

Prompting of LLMs is well-known in the current literature, reflecting the fact that the answers generated by the LLM depend on the association context that is currently activated, and various prompting strategies, as summarized above, activate different contexts for the answer generating process. The present invention optimizes the prompting strategy with the specific properties of generative intelligence in human neurolinguistic function, contrasted with critical intelligence, both of which are fundamental to natural human cognition. These different components of human neurocognitive function have been articulated in the theory of the process of active inference (Luu, Tucker, and Friston, 2024), where the active phase is the generative process and the evaluative phase is a process of error-correction based on external evidence. Because LLMs are derived from the corpus of natural human cognition, prompting based closely on these natural control systems in the present invention will achieve optimal performance for creative generation, on the one hand, and for critical validation, on the other. This property of neurocognitive optimization based on human neurolinguistic processing contrasts with the empirical prompting strategy used in other LLM management schemes.

In the preferred embodiment of a medical chatbot that provides a patient with advice on dealing with a specific condition, such as difficulty sleeping, the generative role optimizes a therapist's initial creative suggestions from its knowledge base, and the evidence-based evaluative role provides complementary feedback to assure that the therapist responses are accurate in relation to the medical evidence and also responsive to the patient's concerns.

### DETAILED DESCRIPTION OF THE INVENTION

The proposed Active Inference Prompting Method leverages the dual-process model of active inference to uniquely optimize LLM responses through directed prompting. This method includes the following steps:

### 1. Generative Stage

In the first, generative stage, the LLM, prompted by instructions to be creative and expansive in generating an initial response based on the query. This response is created in a feed-forward manner, reflecting the creative and expansive aspects of human neurolinguistic function that generate novel hypotheses or actions. Based on the evidence of active inference in human language cognition (Luu et al., 2024), this prompting strategy is optimal for novel creativity of responses.

This mode of prompting the LLM reflects the fact that human brain (the source of the LLMs intrinsic associations) operates in a generative capacity through an impulsive, feedforward mode of control. Engaging this specific control mode is therefore the single unique, optimal method of enhancing the creativity of the LLM.

### 2. Critical Stage

In the critical error-correction stage, another component of the LLM (or a separate LLM instance) critically reviews the initial response. This stage involves checking the response for factual accuracy, coherence, and alignment with domain-specific knowledge.

This critical mode of prompting the LLM optimizes the use of feedback mechanisms to identify errors or inconsistencies in the initial response, providing corrections or generating an alternative response that better aligns with the validated knowledge base. This is because the human brain organizes its cognitive operations through error-correction of generated predictions through critical constraint (Luu et al., 2024), thereby providing the single optimal mode of error-correcting valid responses from the LLM.

### 3. Integration and Output

The final response to the user is composed based on a third stage that evaluates the outputs of both the generative and critical stages, and organizes a final response that reflects the evaluated merits of both actor and critic stages. The two-staged structured interaction thereby builds on the implicit semantic associations of the human brain that are embedded in the associations of the LLM, thereby ensuring that the response not only embodies creative problem-solving but also meets high standards of accuracy and reliability.

### Applications and Advantages

### 1. Education and Tutoring

Problem: AI-driven educational platforms can often generate responses or advice that are not perfectly aligned with educational standards or learning objectives, leading to gaps in instruction or confusion.

Generative-Critical Model: In an educational setting, the Generative LLM could generate learning material, problem-solving advice, or personalized feedback for students, while the Critical LLM ensures that the responses are pedagogically sound, accurate, and appropriate for the student's level.

Potential Impact: This approach could improve the quality of AI-assisted tutoring systems, ensuring they not only engage students creatively but also guide them within the boundaries of correct knowledge and method, fostering better learning outcomes.

### 2. Legal Services

Problem: In legal settings, AI must navigate complex rules, regulations, and precedents to provide legally sound advice. Errors or inappropriate guidance can have serious legal consequences.

Generative-Critical Model: The Generative LLM can generate initial legal advice or draft contracts, while the Critical LLM could assess these outputs for compliance with current laws, legal precedents, and ethical standards. The Supervisor could also highlight areas of potential legal risk or ambiguity.

Potential Impact: This dual-check system could greatly enhance the reliability of AI-driven legal tools, reducing the risk of providing inaccurate or incomplete legal advice and helping lawyers and clients make better-informed decisions.

### 3. Financial Services and Investment Advisory

Problem: In the financial sector, decisions related to investments, savings, or loans are highly sensitive to both market conditions and client-specific needs. AI-generated advice might miss nuances or produce risky recommendations without careful oversight.

Generative-Critical Model: The Generative LLM can generate investment strategies or financial advice based on market data and personal preferences. The Critical LLM would critically evaluate this advice to ensure that it aligns with financial regulations, risk tolerance, and client goals.

Potential Impact: This model could enhance AI-driven financial services, providing personalized yet carefully regulated advice. It would help balance the creative identification of investment opportunities with necessary risk management and legal compliance.

### 4. Human Resources (HR) and Hiring

Problem: AI systems used in HR for hiring, performance reviews, or team management could unintentionally introduce biases or generate inappropriate feedback due to the complexities of human interaction and organizational culture.

Generative-Critical Model: The Generative LLM might generate suggestions for hiring, employee evaluations, or conflict resolution strategies. The Critical LLM would review these suggestions, checking for bias, legal compliance (e.g., avoiding discrimination), and alignment with company policies and culture.

Potential Impact: This approach would make HR processes more fair and consistent, reducing the risks of biased or inappropriate decisions while still promoting innovative solutions to team dynamics and employee growth.

### 5. Creative Writing and Content Generation

Problem: AI is increasingly used to generate content, from marketing copy to creative storytelling, but there is often a need to balance creative freedom with brand messaging, appropriateness, or ethical standards.

Generative-Critical Model: In content creation, the Generative LLM could generate initial drafts or creative ideas, while the Critical LLM ensures that these outputs are on-brand, meet ethical guidelines, and avoid potentially offensive content.

Potential Impact: This system could enhance AI's role in generating creative content that is both imaginative and compliant with ethical, cultural, or brand standards, ensuring that creativity does not come at the expense of appropriateness or message consistency.

### 6. Psychological and Counseling Services

Problem: AI-driven mental health tools can be helpful, but providing therapeutic advice requires both sensitivity and accuracy, as poor advice could negatively impact users.

Generative-Critical Model: The Generative LLM could offer support and coping strategies for common psychological issues (e.g., anxiety, stress management). The Critical LLM would review these responses, ensuring they align with psychological best practices and do not unintentionally cause harm.

Potential Impact: This framework could make AI-powered mental health tools safer and more effective, helping users in a supportive yet clinically appropriate way.

### 7. Customer Service and Support

Problem: AI-powered customer service tools often generate generic or inaccurate responses, leading to customer frustration. Ensuring high-quality, helpful, and brand-aligned responses is essential for good customer experiences.

Generative-Critical Model: The Generative LLM would generate responses to customer inquiries or complaints, while the Critical LLM checks these responses for accuracy, empathy, and adherence to company policies.

Potential Impact: This system could improve the quality and consistency of AI customer service, ensuring that responses are not only quick and efficient but also accurate and empathetic.

### 8. Scientific Research and Data Analysis

Problem: In scientific research, AI models must process vast amounts of data and generate hypotheses or findings. However, errors in data interpretation or incorrect inferences can lead to false conclusions.

Generative-Critical Model: The Generative LLM might propose research hypotheses or analyze data sets, while the Critical LLM evaluates these hypotheses for scientific soundness, checking against established theories and ensuring that the analysis is statistically and methodologically correct.

Potential Impact: This framework could enhance AI's role in research by ensuring that creative hypothesis generation is balanced with rigorous scientific scrutiny, reducing the risk of false positives or flawed conclusions.

### 9. Product Design and Engineering

Problem: AI can assist in generating innovative product designs, but unregulated creativity might produce impractical or unsafe designs.

Generative-Critical Model: The Generative LLM could generate new product concepts or solutions, while the Critical LLM reviews these designs for feasibility, safety, and alignment with engineering standards.

Potential Impact: This approach could help product designers leverage AI to explore creative solutions while ensuring that these solutions are practical, safe, and viable for production.

### 10. Entertainment and Gaming

Problem: In interactive gaming or entertainment platforms, AI can create dynamic narratives and user experiences, but maintaining coherence and user satisfaction is challenging.

Generative-Critical Model: The Generative LLM could generate creative storylines, character interactions, or game dynamics, while the Critical LLM ensures these are coherent, engaging, and aligned with the overall game design and user expectations.

Potential Impact: This could enhance the development of AI-driven interactive experiences that are both innovative and maintain a high standard of quality and coherence.

### DESCRIPTION OF THE DRAWING

FIG. 1 illustrates the unique nature of the present neuropsychological prompting method for LLMs, based on the human brain's mechanisms of active inference that involve generation first and criticism second. Because LLMs are constructed from a large human language corpus, the common empirical methods of prompting will struggle with the inherent variability of surface language structure to achieve the optimal context for both creative generation and accurate validation. In contrast, the present method, based on the principles of active inference in the brain, will achieve the optimal semantic context prompting for creative yet validated language use.

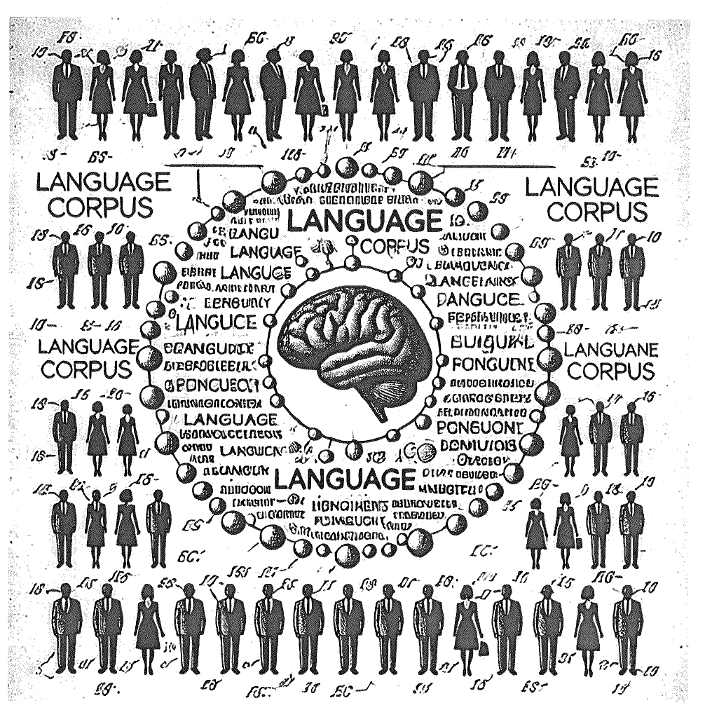

In FIG. 1, an imaginative illustration of the complexity and diversity of the human language corpus used in the construction of LLMs (people at the periphery reflecting the generators of the language corpus), with the language corpus shown in the middle ring, whereas the brain in the center illustrates the neuropsychological process of active inference in the human brain comprising the separable mechanisms of generative creativity and critical validation that are the optimal foundations for LLM prompting.

### CONCLUSION

This invention presents a novel approach to optimizing the responses of LLMs by incorporating an actor-critic architecture grounded in active inference principles. By mimicking the human cognitive process of generating and refining expectancies, this method enhances the balance between creativity and accuracy in LLM outputs, making them more suitable for high-stakes applications.

### BIBLIOGRAPHY

Friston, K. J., & Frith, C. D. 2015. Active inference, communication and hermeneutics. Cortex, 68, 129-143.
Luu, P., Tucker, D. M., & Friston, K. 2024. From active affordance to active inference: vertical integration of cognition in the cerebral cortex through dual subcortical control systems. Cerebral Cortex, 34(1), 1-30.

1. A method for optimizing responses from a Large Language Model (LLM) using an actor-critic architecture, comprising:
a. Generating an initial response to a user query using a generative component of the LLM, wherein the generative component operates in a feed-forward manner to produce a novel response based on the input query;
b. Evaluating the initial response using a critic component of the LLM, wherein the critical component reviews the response for accuracy, relevance, and reliability against a validated knowledge base;
c. Modifying the initial response based on the evaluation from the critical component to produce a final response that balances creativity and factual correctness; and
d. Delivering the final response to the user.

2. The method of claim 1, wherein the generative component and the critical component are distinct instances of the LLM configured to perform different functions, the generative component for generating responses and the critical component for evaluating responses.

3. The method of claim 1, wherein the generative component is prompted with natural language instructions designed to encourage creativity and novel problem-solving in the generated response.

4. The method of claim 1, wherein the critical component uses a feedback loop to assess the generated response for errors, inconsistencies, and alignment with domain-specific knowledge, providing corrections or recommendations for refinement.

5. The method of claim 1, further comprising restricting the knowledge base accessed by the critical component to a domain-specific dataset to enhance the relevance and accuracy of the final response.

6. The method of claim 1, wherein the generative component is configured to emulate the cognitive process of generating expectancies, and the critical component is configured to emulate the cognitive process of error correction, both based on the principles of active inference.

7. The method of claim 1, further comprising the step of integrating the final response from the critical component with contextual cues from the original query to enhance user engagement and satisfaction.

8. The method of claim 1, wherein the generative and critical components operate sequentially, with the generative component producing an initial response followed by the critical component's evaluation, modification, and finalization of the response.

9. The method of claim 1, wherein the final response is produced through a recursive process, allowing multiple iterations between the generative and critical components to achieve optimal balance between creativity and accuracy.

10. A system for optimizing Large Language Model (LLM) responses, comprising:
a. A generative module configured to generate an initial response to a user query by producing novel outputs based on input prompts;
b. A critical module configured to evaluate the initial response from the generative module for accuracy, relevance, and reliability, and to provide feedback for modifying the response;
c. A controller configured to coordinate the interaction between the generative module and the critical module, ensuring the final response is optimized for both creativity and accuracy.

11. The system of claim 10, wherein the generative module and critical module are implemented as separate instances of the same or different LLM architectures.

12. The system of claim 10, wherein the critical module is configured to access a domain-specific knowledge base to validate the accuracy and relevance of the initial response generated by the actor module.

13. The system of claim 10, further comprising a user interface configured to present the final response to the user and receive feedback for further refinement.

14. A non-transitory computer-readable medium storing instructions that, when executed by a processor, cause the processor to perform the method of any of claims 1 to 9.
